(19) United States
(12) Patent Application Publication
(10) Pub. No.: US 2016/0239284 A1
(43) Pub. Date: Aug. 18, 2016

(54) Deep linking of mobile apps by barcode, sound or collision

(71) Applicant: Wesley John Boudville, Perth, WA (US)

(72) Inventor: Wesley John Boudville, Perth, WA (US)

(21) Appl. No.: 14/544,763

(22) Filed: Feb. 18, 2015

(51) Int. Cl. G06F 9/445; H04W 76/02; G06K 7/10; H04L 29/08

(52) U.S. Cl. CPC G06F 8/61; H04L 67/10; H04W 76/02; G06K 7/10722

(57) ABSTRACT

Jane and Bob are near each other, with mobile devices. Jane runs an app. One use case is that Bob wants to install that app on his device. A barcode is made to encode a Deep Link (DL) on Jane's device. Bob's device decodes the barcode and uses the DL to contact the app server, to install the app. Another use case is that Jane's app is multiuser. Bob wants to join Jane as the second user in her app. Her app encodes a DL in a barcode. His device decodes and gets the DL. Leading to the app running on his device, as the second user of Jane's instance. Another use case is that Bob wants to watch Jane's use of her app, on his device. Her app encodes a DL in a barcode. His device decodes and gets the DL. It runs an instance of the app, that gets read only data from Jane's app. If the app is a game, this is e-sports, in the new context of mobile devices. Another use case is hand off. Jane plays an app and wants to stop. Bob takes up her game position by scanning a barcode on her device, that encodes a DL. Other means of transmitting the DL are used. Audio (“chirp”) from Jane's device. Or the devices are collided.

### REFERENCES CITED

“Apps everywhere but no unifying link” by C. Dougherty, New York Times, 5 Jan. 2015.

“Generating and presenting deep links” by V. Tankovich et al, US Patent Application 20130110815 (Oct. 28, 2011).

“Methods and systems for facilitating an online social network” by C. Evans, US Patent Application 20140089413 (Dec. 6, 2013).

“Text-synchronized media utilization and manipulation based on an embedded barcode” by C. Evans, US Patent application 20130334300 (Mar. 27, 2013).

“Smart link system and method” by J. Chor, U.S. Pat. No. 8,433,800, (28 Feb. 2011).

“Bump suppression” by A. Huibers, U.S. Pat. No. 8,531,414 (10 Sep. 2013).

“Matching devices based on information communicated over an audio channel” by A. Huibers et al, US patent application 20130130714.

“Bump button” by A. Huibers et al, US patent application 20130217335.

“Bump validation” by A. Huibers, U.S. Pat. No. 8,577,292 (5 Nov. 2013).

“Data communication system” by P. Bergel et al, US patent application 20120084131 (5 Apr. 2012).

(Web references are from January 2015)

chirp.io

branch.io

mobiledeeplinking.org

urx.com

### TECHNICAL FIELD

The invention describes the use of mobile devices near each other, where one or both of the devices is running a mobile app.

### BACKGROUND

Mobile apps have a distinctive problem. Most are currently standalone programs, that often just converse with a specific server. The apps do not have URL links within them.

It is much harder for a search engine, which is optimised to search the Web for webpages, to search arbitrary apps. There is no standard syntax equivalent to an URL or URI to enable this.

To enable such and other functionality in mobile apps has been termed ‘deep linking’ within apps. (The term also has an earlier use that refers to standard web pages and URL links within them. This submission does not use that earlier meaning.)

Major companies have several projects aimed at defining deep links. Facebook Corp. has App Links. Google Corp. has App Indexing. Twitter Corp. has App Cards. There are also several startups, like Branch Metrics Corp. and URX Corp., with their own initiatives. The syntax and functionality vary between these company-specific efforts.

### SUMMARY

We describe the use of a Deep Link (DL) with a DeepLinker and a Deep Link Server. The Deep Link lets a mobile app interact with other devices on the Internet. A DeepLinker runs on a mobile device and is the analog of a web browser. It sends a DL to a Deep Link Server. The latter is the analog of a web server. A Deep Link Server gets a DL and returns a result or begins an interaction with the DeepLinker. In general, the result could be but is not limited to being a web page.

Two users, Jane and Bob, are near each other, with mobile devices. Jane runs an app. One use case is that Bob wants to install that app on his device. The method uses a barcode to encode the DL on Jane's device. Bob's device scans it and decodes the DL. A DeepLinker is started, to install the app.

Another use case is that Jane's app is multiuser. Bob wants to join Jane in running the app on his device, as the second user in her app instance. Her app encodes a DL in a barcode. His device decodes and gets the DL. A DeepLinker loads the DL, leading to an instance of the app running on his device, as the second user of Jane's instance.

Another use case is that Bob wants to watch Jane's use of her app, on his device. Her app encodes a DL in a barcode. His device decodes and gets the DL. It runs an instance of the app, that gets read only data from Jane's app. If the app is a game, then we have e-sports (electronic sports), in the context of mobile devices.

Another use case is hand off. Jane plays an app and wants to stop. Bob takes up her game position by scanning a barcode on her device, that encodes a DL.

Other means of transmitting the DL are used. Audio (“chirp”) from Jane's device. Or the devices are collided (“bump”).

### BRIEF DESCRIPTION OF THE DRAWINGS

FIG. 1 shows a DeepLinker and a DeepLink server.

FIG. 2 shows Jane and Bob near each other, with mobile devices.

FIG. 3 shows Jane's app with a menu of use cases.

FIG. 4 shows Jane's app adding Bob as a user, where the apps talk to a server.

FIG. 5 shows Bob's device installing the app directly from the app server.

FIG. 6 shows Jane's app adding Bob as a user, where only Jane's app talks to the server.

FIG. 7 shows Bob's device installing the app directly from the app server.

FIG. 8 shows Bob's device installing the app from Jane's device.

FIG. 9 shows Jane's app adding Bob as a watcher, where the apps talk to a server.

FIG. 10 shows Bob's device installing the app directly from the app server.

FIG. 11 shows Jane uploading data to a Collision Server, which installs to Bob's device.

FIG. 12 shows Jane and Bob using a Collision Server to get Bob an instance of Jane's app.

FIG. 13 shows a menu of transmission options on Jane's device.

FIG. 14 shows the use of an Audio Server.

FIG. 15 shows Jane and Bob using an Audio Server to get Bob an instance of Jane's app.

FIG. 16 show Jane controlling a screen by scanning a barcode on the screen.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, U.S. Pat. No. 8,821,277 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, US patent application 20140098644 [“7”]; “Barcode-based methods to enhance mobile multiplayer games”, filed 22 May 2013, US patent application 20140349746 [“8”]; “Barcode, sound and collision for a unified user interaction”, filed October 2013, U.S. patent application Ser. No. 13/998,280 [“9”].

We define some terminology.

This submission is about mobile devices carried or worn by people. The most common mobile device is a cellphone. We take this word to also include “smartphone”. The latter term arose to describe a cellphone that also had a camera and Internet access, when such features were relatively new to cellphones. Other types of mobile devices are tablets, laptops, notebooks, netbooks, PDAs and wearable devices.

There is no single industry standard for solving the deep linking problem of mobile apps. However, this submission describes functionality different from current uses and proposals.

For convenience, we assume that a deep link (DL) is expressed as a string, instead of a raw binary sequence. This follows from the success of the URL form of http:// and https://. The string names of these URLs meant that they are human readable and editable. Likewise, we expect that any widely used format of a deep link will also be a string. The string need not necessarily be confined to Ascii characters. Unicode characters might be possible.

We assume that the various proposed methods for deep links are valid, in that they offer addressing means for links from within an app, to other assets on an electronic network. Instead, we go onward to then describe what could be done, given this as a starting point.

Existing efforts differ from each other in the syntax. Our submission thus avoids any dependency on a specific syntax of a DL.

The fundamental motivation (the “why”) of this submission is to increase the use of a mobile app. This is implemented in several basic use cases. The use cases all describe 2 or more users with mobile devices, next to each other. The users can be strangers. The common problem is reduced to this issue—how to pass a DL across the air gap between the devices?

The submission has the following sections.

1: DeepLinker;

2: Use case=Install;

3: Use case=Add user;

4: Use case=Add watcher (e-Sports);

5: Use case=Hand off;

6: Bump transmission of a Deep Link;

7: Chirp (audio) transmission of a Deep Link;

8: Other transmission methods;

9: Use case=Other Apps;

10: Use case=Trade;

11: Privacy;

12: Barcode to control screen;

13: Adding identifiers to a DL;

1: DeepLinker;

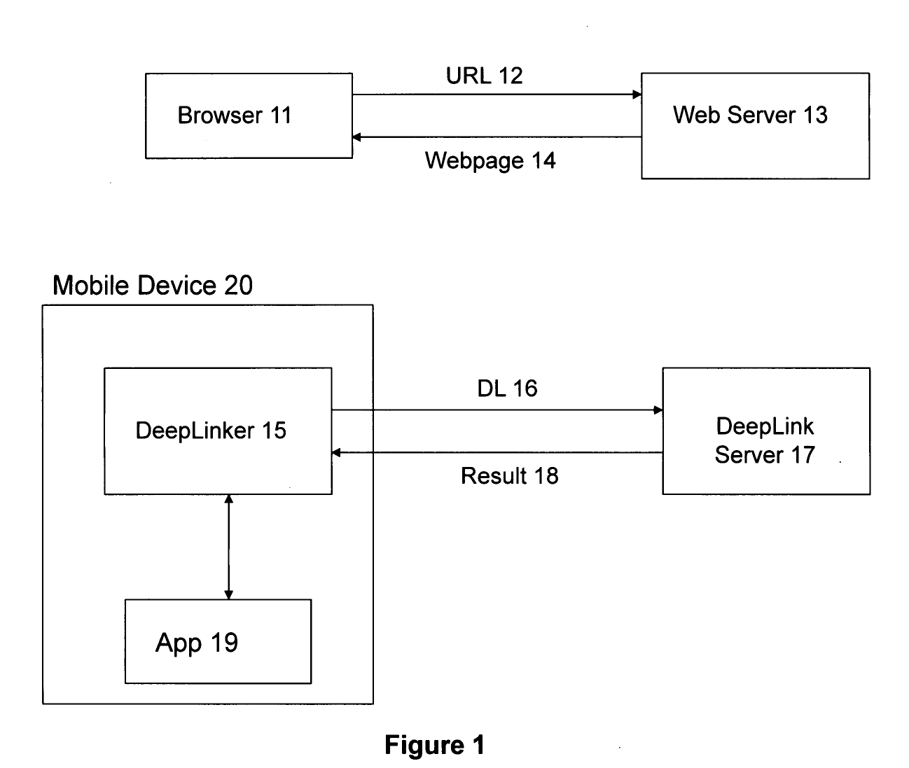

Consider FIG. 1. The top part shows the current use of a web browser and a web server. Browser 11 sends an URL 12 to Web Server 13. Where the address of Web Server 13 was in, or derived from, URL 12. Web Server 13 performs some computations and then sends Webpage 14 to Browser 11, which displays it.

Note that Browser 11 got URL 12 by several possible means. One might be that the user typed URL 12 manually into the address bar of Browser 11. Or, the user picked an URL that was in the list of bookmarks of Browser 11. Or, of course, if Browser 11 was already showing a webpage, and the user picked a link or clicked a button, which caused Browser 11 to make an URL by the instructions in the webpage.

By analogy, we have what we term DeepLinker 15. Preferably, it runs on a mobile device. It gets a deep link DL 16 by some means. DL 16 would typically, or always, have an address in it. DeepLinker 15 parses DL 16 to extract this address. It sends DL 16, or some modification of it, to the address. At that address is assumed to be a server program we call DeepLink Server 17.

DeepLink Server 17 gets DL 16 and does some computation. It sends Result 18 to DeepLinker 15.

DeepLinker 15 and App 19 are inside Mobile Device 20. App 19 is a mobile app that, for example, might have gotten a DL by some means. It passes the DL to DeepLinker 15 which then communicates with an external DeepLink Server 17.

DeepLinker 15 can then be considered to be the library of routines that handles the use of a DL.

In FIG. 1, we drew DeepLinker 15 as being separate from App 19. This is one possibility. Where the mobile operating system comes with some DL handling routines, that it makes available to apps. This frees the app writer from having to explicitly include the DL library within each app. In this case, DeepLinker 15 might not have any graphical user interface (GUI) routines, in one implementation. It would be the responsibility of an app that calls these routines to implement a GUI.

However, another possibility is that some app writers might choose to include their own DL library within the executable of their app. Perhaps because their library has some unique or advanced DL handling features not furnished by the default operating system DL library. Or because the mobile app industry has not converged on a single widely accepted DL standard.

FIG. 1 does not depict this possibility. But it is a minor modification, where the reader is asked to imagine DeepLinker 15 embedded in App 19.

Often, DeepLink Server 17 will not be running on a mobile device. Since also typically we stated that the DeepLinker will run on a mobile device, it means that the two programs run on different devices. Occasionally, both might run on the same device, where the DeepLinker makes a network connection to that DeepLink Server.

What Result 18 is can vary. One important case is where it is in the format of a web page, written in HTML. In this case, DeepLinker 15 can then act as a standard web browser, and show this page. Where it is assumed that if the page has selectable items like web links or buttons, that the user can select them. However, other types of DeepLinker 15 might not have access to the display of the mobile device.

In the following sections, we describe several configurations of DeepLinker 15 and DeepLink Server 17 along with the items they pass between themselves.

FIG. 1 is a way to understand easily how a deep link DL can be used. It models at a top level. This submission does not claim that every existing or proposed use of a deep link can be put into this framework.

We said above that the DL would often or always have in it the network address of a DeepLink Server. The network address could be written in a raw format, or perhaps as a domain name.

In some implementations of the DL and of the DeepLinker, the DL might not have a network address of a DeepLink Server. This can be if the DL is stateful. For example, a DeepLinker might get two DLs. The first has a network address. The DeepLinker extracts this and holds it in memory. The DeepLinker then makes a connection using the DL to the specified DeepLink Server. It gets back some result. The second DL does not have a network address. But the DeepLinker uses the cached address to send the DL to that DeepLink Server.

An advantage is that the notation of the DLs might be shortened, if only the first DL in a sequence has an address. This is in contrast to the use of URLs, which are meant to be stateless.

For simplicity in the following sections, we will assume that a DL always has an address of a DeepLink Server.

2: Use case=Install;

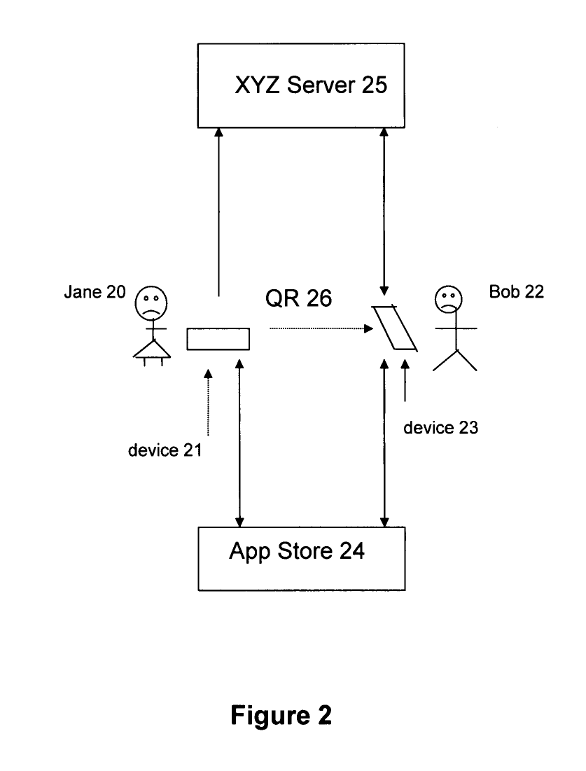

Consider FIG. 2. It shows Jane 20 with her mobile device 21, near Bob 22 with his mobile device 23. For simplicity, we initially assume that there is only one App Store 24, and both devices 21 and 23 use it.

The first use case, and the most important, is where Jane is running an app on device 21. Call this app XYZ. At some earlier time, she installed this app from App Store 25. Or perhaps the app came pre-installed when she bought her device. Jane talks about her app and perhaps shows Bob the app in her screen. Bob does not have the app on his device 23.

The key assumption is that the company that made the app wants as many people to use it as possible. It wants the app to propagate widely.

Suppose by a combination of Jane's talking and her showing Bob the app on her device, Bob wants the app. How does he get it? Currently, in the prior art, Jane would speak the app's name. Bob searches his app store, by typing in the app's name. But each letter in the name is a key click. This is clumsy, slow and error prone on his device. Especially if the device only has a virtual keyboard (in order to maximise screen size). So Jane and Bob might have to go back and forth verbally before he types the correct name.

But even here, that correct name could lead to several candidate apps on Bob's screen. If the name that Jane says is short, this could happen, given other apps with similar names. While if she gives a longer name, that is more keys for Bob to type and more chances of error.

It is important to note an asymmetry. Jane has developed some skill in using the app. Maybe she has even paid a fee to the app company. She has invested time and money in learning the app. Bob has not invested any time or money in the app. He is brittle. The more manual steps he has to do to install the app, the greater the chance of error. And the greater the chance that he will simply abandon his effort.

The above supposes that she does not send him an email with the necessary information about the app. Where this might have a link that he could click to install it. We are not assuming that they know each other. This is the most general case for an arbitrary Jane and Bob. So if Bob were to tell her his email address, now Jane has the manual effort of correctly typing it.

The solution to this first use case is as follows. Jane brings up an option in her app, “Install”. There could be various graphical means to do so. In this submission, they are all considered equivalent. She picks this option.

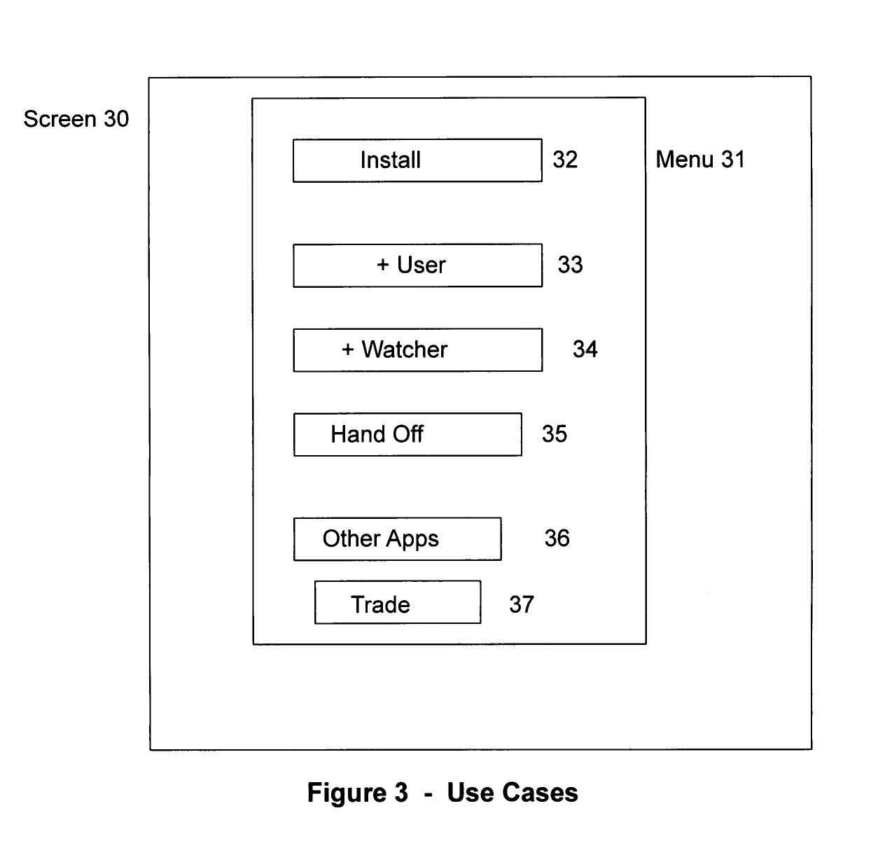

FIG. 3 shows an example of a menu which the app brings up. Screen 30 can be the screen of the device. Or a graphical window within the screen, where the window is under the control of the app. Within Screen 30 is Menu 31.

The Install 32 item is described in this section. The other items are described in later sections. We stress that there is no requirement that the app allows all these options, or, if it does, to present them in a menu format. But nonetheless, FIG. 3 can be a useful way to understand at a top level, the various use cases.

The app makes a deep link, that points to its address in App Store 24. The app converts the deep link into a barcode, which appears on the screen of Jane's device 21. She shows the barcode to Bob. The barcode is designated as QR 26. The QR stands for a particular type of two dimensional barcode, Quick Response. But we stress that any common two dimensional barcode could be used. For example, an alternative is a Data Matrix barcode.

Bob is assumed to have a function, which could be an app, on his device 23, that can decode the barcode. Currently in the prior art, there are such decoder apps for the iPhone™ and Android™ platforms. A decoder app can then check the decoded data. If the data is a string that starts with “http://” or “https://” (or perhaps one of the lesser used protocols like “ftp://”), then the string is considered to be an URL. The existing app then starts a browser on the device, if the browser is not already running, and loads the URL into the browser.

This submission extends the functionality of those apps. Now, the string is not an URL. Bob's device detects that the string is a deep link. As above, the first step could be to see that the string is not an URL. And a given format of a deep link might have a well known prefix, like “deep://”, that can be used for this purpose. We stress that the current proposals for a deep link do not, to our knowledge, use this specific protocol name. It is meant as a symbolic placeholder for one or more deep link formats.

Bob's device executes the deep link, in a similar way to how when a browser loads an URL, it makes a query across the network to the address in the URL. Likewise, the device makes a query across the network to the address in the deep link.

This address is that of App Store 24. The App Store runs a DeepLink Server, which replies to the query with Result 18. For clarity, we omit specific depiction of a DeepLink Server in App Store 24.

It is assumed that the other data in the deep link specifies the app in question, an instance of which was running on Jane's device. In symbolic terms, we can imagine the deep link to have a format where the first part (reading from left to right) would be a network address, like the way an URL starts with “http://somewhere.com/”, for example. While the rest of the deep link corresponds to a specific sub-address at that network address. Or it corresponds to an action to be done by a DeepLink Server listening at the network address.

Note that these 2 possibilities of an address or an action might both be allowed by a given format of a deep link. How a given deep link might be understood could depend on the DeepLink Server.

Above, when we described actions done by Bob's device, these could be done by a DeepLinker program on his device, as in Section 1. So the initial program on his device would decode the barcode. By inspecting the decoded data, it might start a browser or a DeepLinker, as appropriate.

Result 18 might have an image representing the app, as well as other data. The DeepLinker can show the image on the screen of Bob's device, making the image clickable. Optionally, in this user interface, Bob can then take some action to install it on his device. Perhaps by clicking the image. This tells the DeepLinker to do whatever steps are needed to install the app. These steps might be described in Result 18 in a programmatic fashion. And DeepLinker might have to make other queries to the DeepLink Server or to other servers on the network.

At this stage, the functionality of the DeepLinker to let Bob install an app is equivalent to what an existing App Store button on his device already offers.

Bob does not have to use the conventional prior art method of clicking his App Store button on his device. Because he would then have to somehow search it for the precise app that Jane is using.

The point here is that Bob's manual actions consists of him starting his app that decodes a barcode. And then focusing the camera of his device on the barcode on Jane's screen. He might have to do a click, to take a photo. Or his app might be sophisticated enough to do that.

All this is much simpler for Bob than typing out an app's name in the prior art App Store search routine.

A variant of the above is that instead of the deep link pointing to an App Store, the link might instead point to a DeepLink Server at an address owned by the company that made the app. This could be XYZ Server 25 in FIG. 2.

To the company, this can be desirable, for it lets the App Store be bypassed. The App Store might charge the company to list its apps in the App Store. The App Store might also have a vetting process for quality control or whatever other criteria it deems necessary.

Conversely, the DeepLinker might have a policy, which can be set or altered by Bob, to run a deep link to only go to a set of approved App Stores, instead of going to an arbitrary address on the network.

This whitelist of approved App Stores might include those run by Apple Corp. and Google Corp. and Microsoft Corp., for the mobile devices made or licensed by those companies.

Now suppose that Jane's device is running a different operating system than Bob's device. For example, she might be running Android, and Bob is running an iPhone. Her app runs on Android. She does the earlier steps about having the app make a barcode with a deep link for “Install”.

This deep link could have a parameter in it, in a published format known to the DeepLinker on Bob's device. The parameter tells of the operating system on Jane's device. It might tell of the specific version of her operating system. Bob's DeepLinker extracts the parameter. It finds that it describes a different operating system. So it does not contact the official App Store corresponding to Jane's device.

What if company XYZ has a version of the app that would run on Bob's device? Notice that if the company puts the address of the official Android App Store into the Android version of its app, then that App Store can scarcely be expected to tell Bob's device of a competing iPhone App Store.

Instead, the company could put in the Android version of its app a deep link that points to the company's Deep Link Server. Then, Bob's DeepLinker could have a (small) list of the known addresses of the official app stores for most mobile devices. The DeepLinker parses the deep link from the barcode, and gets the address. It checks this against the list. When the address is not on the list, it assumes the address to be that of the app company. So the DeepLinker sends the deep link to that address.

The company's Deep Link server can then reply with a page, possibly in the format of a web page, that shows the various versions of the app. The DeepLinker shows this page on the screen. Bob then picks the one for his device.

This can be optimised. For example, when the DeepLinker on Bob's device sends the deep link, the format of this might let the DeepLinker insert a parameter that describes its operating system. So the Deep Link server on XYZ Server 25 can automatically check if it has an app for that operating system. If so, then instead of returning a page that Bob has to manually pick from, and possibly make an error, he just gets a page asking if he wants to install the app, as in the earlier case.

Or, instead of the DeepLinker on Bob's device modifying the deep link to describe the DeepLinker's operating system, the result from the Deep Link server could have several choices; one for each operating system supported by the company.

The DeepLinker can pick the appropriate one. This might then trigger another call to the Deep Link server, to get whatever are the installation instructions for that operating system version. But the main point is that Bob does not have to choose between versions.

3: Use Case=Add User;

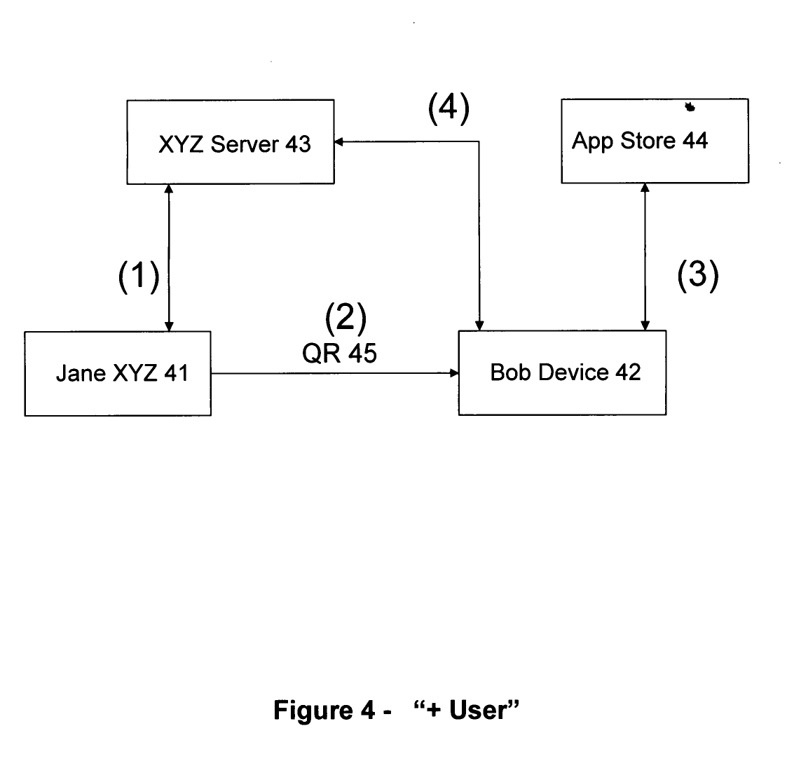

We now consider another major use case. In FIG. 2, now Jane is assumed to be running a multiuser app, where she is the first user. She needs a second user. The app is XYZ. In FIG. 4, Jane XYZ 41 refers to this app, running on her mobile device 21. FIG. 4 has the labels (1), (2), (3) and (4). These indicate the time ordering of the steps to be described below, in order of increasing time.

We assume app XYZ uses a client server model, where the app is the client, and it communicates with XYZ Server 43. Commercially, this is an important model. It lets the firm making XYZ monetise in some fashion, by having the app interact with a server run by it.

When Jane starts the app and it talks with Server 43, the server assigns an id to this instance.

Bob is nearby, as in FIG. 2. What is the simplest way for him to run XYZ on his device, and have that instance interact with Jane's instance?

Jane picks the menu option “+User 33” in FIG. 3. Her app talks with Server 43. Server 43 can either make a DL and send it to her app, or it can send sufficient information so that the app can make the DL. These are equivalent steps.

Another possibility is that Jane's app has already communicated with Server 43 when the app started. The server has assigned an id to the app instance and downloaded the id to the app. Given this, the app might be able to make a DL that embeds the id and another id that designates the “+User 33” option. So there is no need for the app to make another call to the server.

All 3 choices are collectively considered step (1) in FIG. 4.

The DL has the id of Jane's app instance. Her app makes a barcode, designated as QR 45 in FIG. 4. Again, any common barcode format could be chosen; not just Quick Response. QR 45 appears on Jane's device screen. She shows it to Bob in step (2).

Bob uses his Device 42 to take a photo of the barcode and decode it, as described earlier. This starts a DeepLinker on Device 42.

Suppose that the DeepLinker finds that app XYZ is not installed on Device 42. It can do the steps in the previous section to install XYZ. Collectively, this is step (3) in FIG. 4.

Now, the DeepLinker starts XYZ and loads it with DL. XYZ uses DL to make a connection to XYZ Server 43. The Server gets DL and extracts the id of Jane's XYZ. This tells it that Bob's XYZ instance is to be the second user in Jane's XYZ instance. The Server can now send and get data and commands to and from both XYZ instances. This is step (4).

The key advantage is that Bob only had to do a few manual steps to find himself in a multiuser interaction with Jane's app.

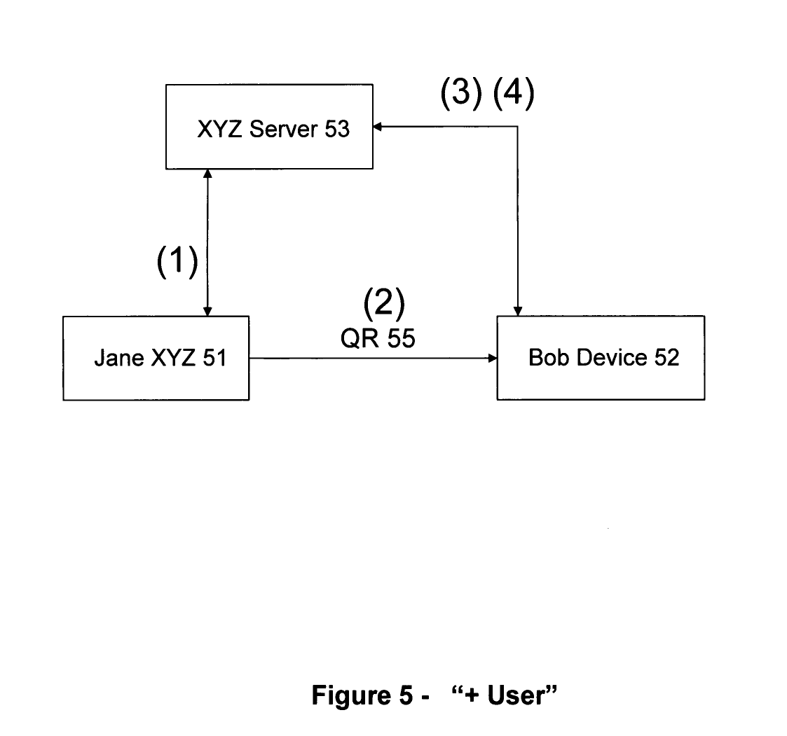

FIG. 5 shows a variant. To the XYZ company, it is an important advance over FIG. 4. Suppose Bob does not have the app installed. Why should he go to the App Store, which is run by another company, and which will charge XYZ company for the install?

Step 1 in FIG. 5 is the same as Step 1 in FIG. 4. Bob Device 52 decodes the DL from barcode QR 55 in step 2. If the device needs to install XYZ, the address in the DL points to XYZ Server 53, in step 3. This bypasses the App Store in FIG. 4. So the app comes directly from the server. Step 4 in FIG. 5 is the same as step 4 in FIG. 4, where the app updates via the server.

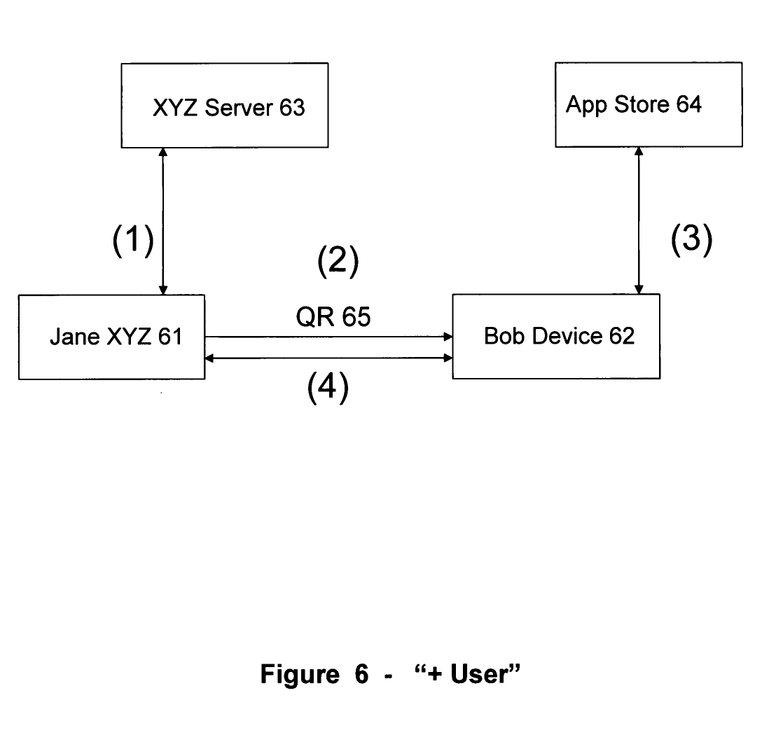

FIG. 6 shows a variant. Instead of Bob's instance talking directly to the Server when the apps are interacting, only Jane's instance does so. In this case, Jane's XYZ 61 starts up and contacts Server 43. XYZ 61 makes a DL, where the address in the DL is the address of Jane's device. The DL is made into barcode QR 65. Bob's device scans and decodes it into the DL.

A DeepLinker is started on Bob's device. As earlier, any necessary steps are done to install XYZ on his device if it does not already exist, using App Store 64. Then an instance of XYZ is started and loaded with the DL. This causes XYZ to communicate with Jane's device, where it is assumed that her XYZ instance has a DeepLink Server subprogram to answer Bob's instance.

Her instance will handle all updating to and from Server 63 of the interaction between the 2 instances.

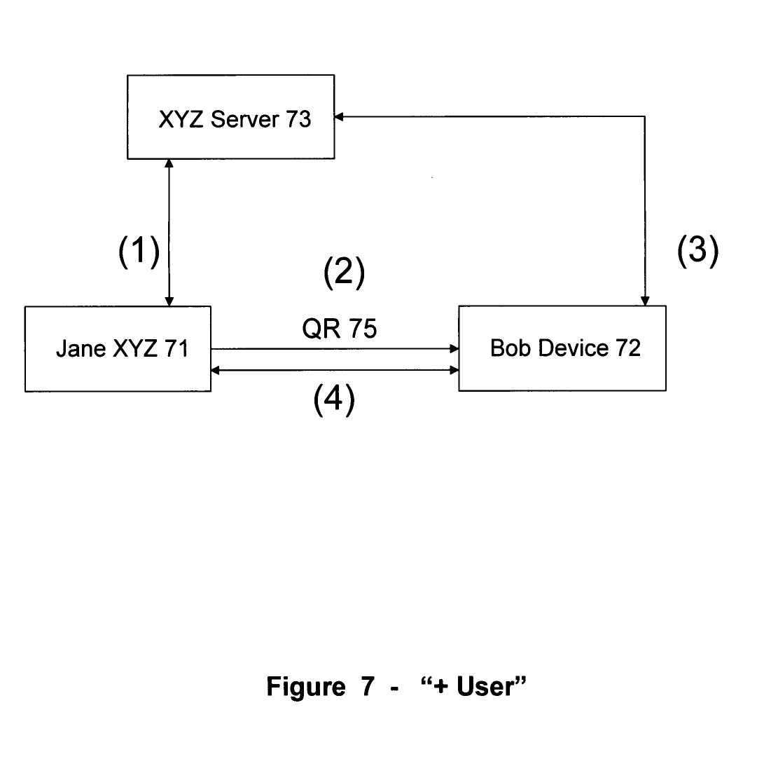

In turn, a variant of FIG. 6 is FIG. 7. Instead of Bob Device 72 going to the App Store in step 3 to install XYZ, the DL it got from decoding the barcode QR 75 in step 2 sends it to XYZ Server 73 to install the app. Then, the interactions between the apps is as in FIG. 6, where only Jane's app directly communicates with the server.

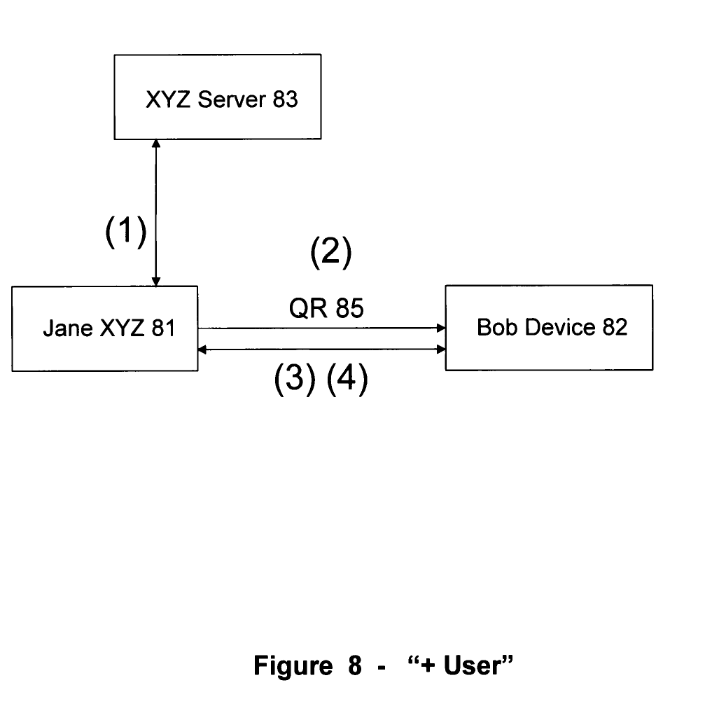

Another variant of FIG. 6 is FIG. 8. Bob Device 82 decodes the barcode QR 85 in step 2 into a DL. But this DL was made by Jane's device 81. If Bob's device does not have XYZ app, it installs a copy of the app from Jane's device 81. This is a case of a mobile device (device 81) acting as a Deep Link Server.

An advantage of doing this instead of Bob's device going to XYZ Server 83 is that it can reduce the bandwidth and workload of that server. While instead of installing from the App Store (not shown in FIG. 8), it saves the company paying a commission.

Above, in this section, we discussed two cases where a barcode encoded a DL. A variant is where the barcode encodes 2 DLs. The first DL might be used by Bob's device to install app XYZ if it does not already exist on the device. The second DL might have the address of a DeepLink Server, which can be XYZ Server 43 or Jane XYZ 61.

4: Use Case=Add Watcher (e-Sports);

Consider a case of a skilled player in a video arcade, playing a video game. She might have an audience of 5 or 6 people staying around her, watching her play on the screen on her video machine. Now consider Jane running some app on her mobile device. It might or might not be a game. If her device is a cellphone, there is no equivalent of the video arcade audience, because the screen of her device is too small for her to easily run the app and let several others see her screen.

Suppose for simplicity that her app XYZ is a single user app. She starts it. Bob and others are near her. They want to see her interact with the app. If the app is a game, we have e-sports (electronic sports), applied to the context of mobile games, which at this time of writing does not exist as a significant market.

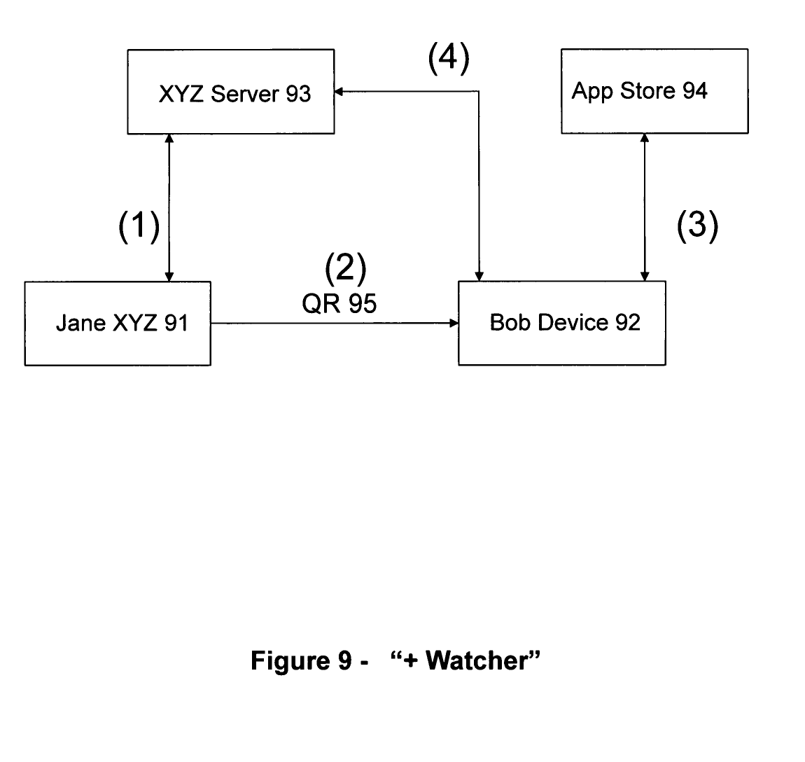

See FIG. 9. Jane is running XYZ 91. This is step (1) in the figure. She brings up the menu in FIG. 3 and picks “+Watcher 34”. This causes the app to communicate with Server 93, asking for an id appropriate for a watcher. The server returns a DL pointing to the server.

Or, as in the previous section, the app makes the DL without contacting the server. Where the app embeds an id of the instance of the app (which it got earlier from the server), and an id of the choice of “+Watcher 34”.

Her app makes barcode QR 95 with the DL. Bob's device 92 scans and decodes it in step (2). And starts a DeepLinker.

As in the previous section, if XYZ does not exist on his device, an interaction with App Store 94 is done, to install it in step (3). Then, his instance XYZ is started and loaded with the DL. This communicates with XYZ Server 93. The server finds the id it made for Jane's instance. It knows from the context of Jane's request for the id, to associate Bob's instance with Jane's instance. This is step (4). This step also encompasses the rest of the interaction, where Bob then watches her, on his device.

If there are others nearby who also want to watch, then she lets them scan her barcode.

Jane resumes interacting with her instance. As she does actions on her device, in tandem with data downloaded from the server, then periodically, these are batched and uploaded to the server. The server downloads these to Bob's XYZ instance. But with instructions that turn Bob's instance into read-only. He can look at his screen to see Jane's actions (or a summary of them). But he cannot click any buttons or do other actions (like swiping his screen) that affect Jane's actions on her device.

The reader should compare FIGS. 4 and 9. They are essentially the same in overall structure. But FIG. 4 is for an active 2 person interaction between 2 instances of an app. While FIG. 9 is for a passive viewing of a first instance by a second instance.

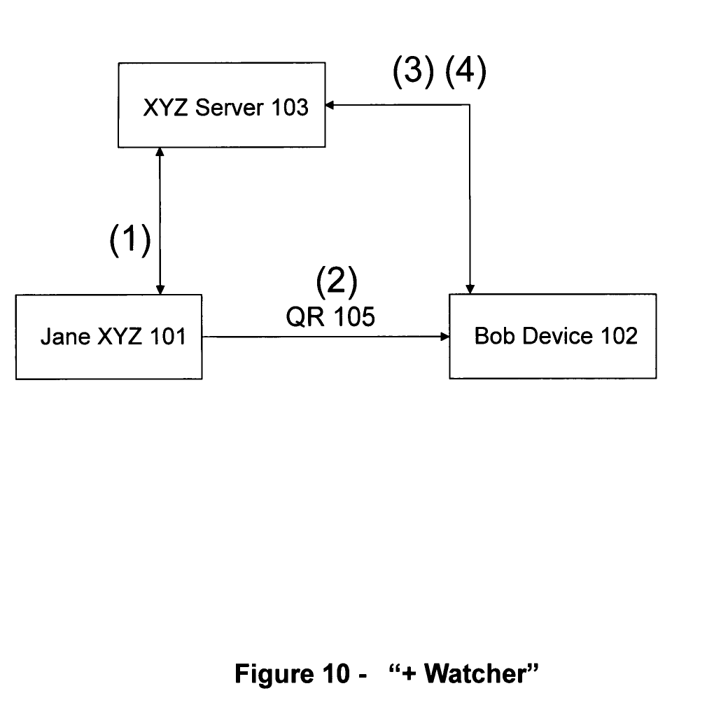

FIG. 9 can be altered to omit any installing from the App Store. We have FIG. 10. This is essentially the same structure as FIG. 5. Step (1) is the start of the app by Jane. Step (2) is the transmitting of the barcode from her device to Bob's device.

If Bob Device 102 does not have XYZ, now it installs it directly from XYZ Server 103 in Step (3). So the company does not have to pay a commission to the App Store when Bob does an install from the latter in FIG. 9. Step (4) is the ongoing watching by Bob of Jane's play, on his device.

For this use case, FIGS. 9 and 10 have an important variant. Step (4) in both figures can instead go between Jane XYZ app 91/101 and Bob device 92/102. Since Bob is presumed to see Jane's Point of View (PoV) in her app use, then Jane's app has all the necessary information to transmit to Bob's device. Her app would put a flag in the transmitted data, or do whatever else is equivalent, so when Bob's device gets the data, it makes a read only display of it. In other words, so that Bob cannot use his device's app instance to communicate with the App Server and alter Jane's game position.

In the earlier use case of Add User, this would not be appropriate in most cases. Because if Bob is an independent player, what he sees in his PoV may be quite different from Jane's. For example, they are in different parts of a 3 dimensional environment, exploring unknown territory. Jane's app would likely not get the data Bob needs.

In Add User, another point is that if Jane's app gets data to send to Bob, she could do an unauthorised change to her app and thence to the data. Perhaps to disadvantage Bob in a game. In the example above, if it is a shooter game, then simply knowing his current location, and him not knowing her's, can be a great boon.

For the current case, if Bob gets his data from Jane, this can lead to reduced bandwidth and computation at the app server. And perhaps faster transmission to Bob, if his data only comes from Jane's device. But her device will have greater outgoing bandwidth and greater computational load, both reasons leading to more power drain.

Also, for the current case, there is no or little incentive for her to somehow modify what data she passes onto Bob. The point of the case is to let him see what she sees.

One caveat is that whether Bob gets his data from the server or from her device, the app might have an option that lets her limit what the watchers can see from her PoV. This might not just be limited to the literal images from her PoV, but perhaps ancillary data, like how much food or energy or ammunition she has left.

We also want to clarify a possible question of terminology. The phrase “App Store” is familiar to the public. In general, to them it refers to an icon or button on their mobile device; where pressing it lets them search a vast number of apps and to install one or more. This App Store is an “app server” in its own right. The App Store is run, typically, by the provider of the mobile device operating system. We draw a distinction between an “App Store” and an “app server”. The latter refers to a server run by a firm that makes (or owns) the apps that it offers for installing. Whereas the App Store in general has apps produced by many independent firms.

Following the discussion in the previous section, now we have a similar case, where instead of Bob's device getting the updated actions of Jane from XYZ Server, now it gets these from Jane's app. This reduces the bandwidth and computational load on the server. We omit an explicit figure for this case. See FIG. 6. In step 4, Bob's device 62 gets read only data from Jane XYZ 61. So his app cannot alter Jane's “game” position.

Here, Jane's app acts as a server. The data passed in the barcode from Jane's device could have an address of Jane's device. So Bob's device queries that address to get updates.

Likewise, when FIG. 6 was altered to produce FIG. 7, the point was to omit any install of the app from the App Store to Bob's device. See FIG. 7, where now the use case has Bob's device installing the app (if it was not already present) by installing from the app server.

Likewise, consider FIG. 8 for the present use case. Here, if the app was not present on Bob's device, it is installed from Jane's device.

5: Use Case=Hand Off;

Consider a real world multiplayer board game. Imagine several people sitting around the game board, playing. You are one of the players. Nearby, Bob is standing and watching the game. You get a phone call and tell the others that you have to leave. Bob asks, can he take your place? You (and the others) say yes. You stand up and leave. He sits down in your place. The game continues.

Now imagine you are playing the game with the others, each player running an instance of an app for the game on a mobile device. The other players could be remote. The apps communicate with a server, that maintains the overall game data.

Bob is near you, talking to you. You get a call, telling you to be elsewhere, or to do something. In either case, you cannot continue playing. You tell this to the other players electronically. Bob asks if he can take your place? You (and the others) agree. He has a mobile device on which he wants to play the game.

You bring up a menu in the app, like FIG. 3, and pick item Hand Off 35. The app makes a DL with the id of your app instance, where this id is known to the server. The address in the DL is of the server. One alternative is that the app asks the server, and the server makes the DL and sends it to the app. There is a second parameter in the DL, which indicates the ‘hand off’ option.

The app makes a barcode encoding the DL. It appears on your screen. You show this to Bob. He starts a program that scans and decodes the barcode. He now has the DL on his device. His device DeepLinker takes the DL.

If his device does not have an instance of the app, then it can go to the address in the DL, to install an instance. This address can be that of an App Store. Or, as discussed in the 2 previous sections, the App Store can be bypassed. The DL points to the game server. So Bob's device can install the app from the server.

The app can then run the DL. It communicates with the server. The server gets the id in the DL. This is of your instance. The server gets the second parameter, ‘hand off’. The server has the data about your player. It replaces the network address of your app instance with the address of his app instance. At a minimum, this is all that is needed to hand off a game position to a new player.

The server might do some simple steps in addition. It could send a farewell message to your app, telling that it successfully transferred your game. It could send a hello message welcoming Bob to the game. Because the server and the app are written by the same company, it can be expected that any instance of the app would show such a status message sent by the server.

Another possible action by the server might be to ask Bob to type his “name”; either a name claiming to be his real name or a nickname. (More likely the latter.) And during the rest of the game, the server might put some symbol by Bob's name if this appears in a status board seen by other players. The symbol could mean that “Bob” is the joint effort of 2 people (you and him) playing consecutively as the same player.

The above was for a player in a multiplayer app. Also, the app might be a single player app. Where the first player has to stop. And a nearby person wants to take up the play.

For a single player app, there are 2 cases. The first is to transfer the play, as above. But now there is another possibility. The server or the first person's app might record the game position before hand off. The game can be transferred. But at a later time, the first player might resume play from the frozen position. Whereas in general facing human players in a multiplayer app, this is not possible.

As earlier, suppose the syntax of an implementation of a DL is insufficient for the DL to be used for both an install and the running of an instance. Then the barcode might encode 2 DLs. The first would handle an install, while the second is for running the instance.

In this section, we motivated the discussion by citing a game app. In general, the app does not need to be restricted to playing a game.

6: Bump (Collision) Transmission of a Deep Link;

Another means of communicating a Deep Link between the devices in FIG. 2 is by collisions, instead of using a barcode. This assumes that Jane's and Bob's devices have accelerometers. This also assumes that both devices know their locations, e.g. by Global Positioning System (GPS) methods. One key case is when both devices are cellphones.

This uses inventions by Bump Corp. (Now bought by Google Corp.) See our submission “9” and the patents and pendings by Google for more details on the prior art.

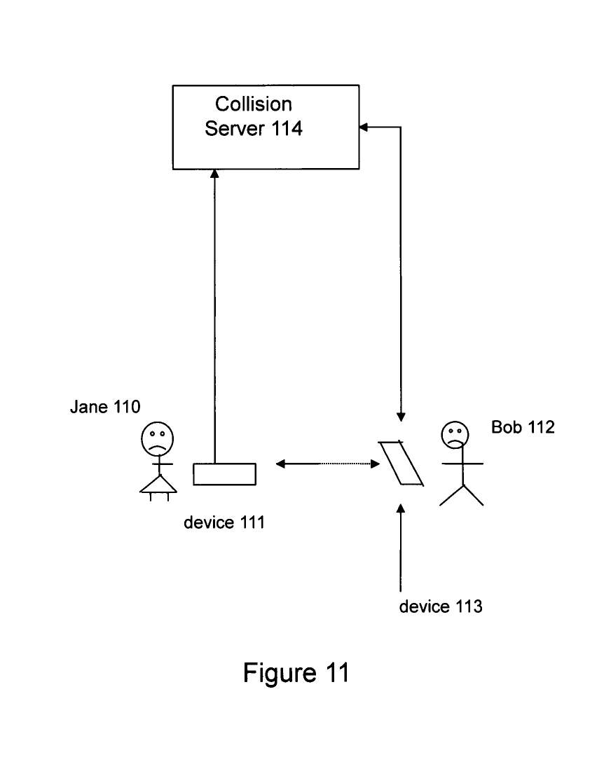

See FIG. 11. It shows Jane 110 with mobile device 111, and Bob 112 with mobile device 113. Jane starts an app on device 111 that makes a DL. It uploads this and its location to Collision Server 114 which is on an electronic network, assumed to be the Internet. Collision Server 114 stores that data. Bob's device 113 uploads its location to Collision Server 114.

In earlier sections, we spoke of the case when a barcode might encode 2 DLs. Corresponding to this, the current section might have Jane's device upload 2 DLs to the Collision Server.

The location data uses external devices; i.e. satellites and possibly basestations of cellular networks. For simplicity, these are not explicitly indicated in FIG. 11.

The users collide their devices, each of which uploads its accelerometer data to Collision Server 114. The latter then uses the location and accelerometer information to infer that the data uploaded by Jane's device 111 is meant to go to Bob's device 113. The server downloads the data to device 113.

Once device 113 has that data, the submission then proceeds as in earlier sections, after the barcode was decoded by Bob's device.

Qualitatively, a difference with earlier sections is that the use of collisions needs the existence of another external server (Collision Server). Whereas when a barcode was used, the data to be transmitted could be encoded and decoded entirely on the mobile devices.

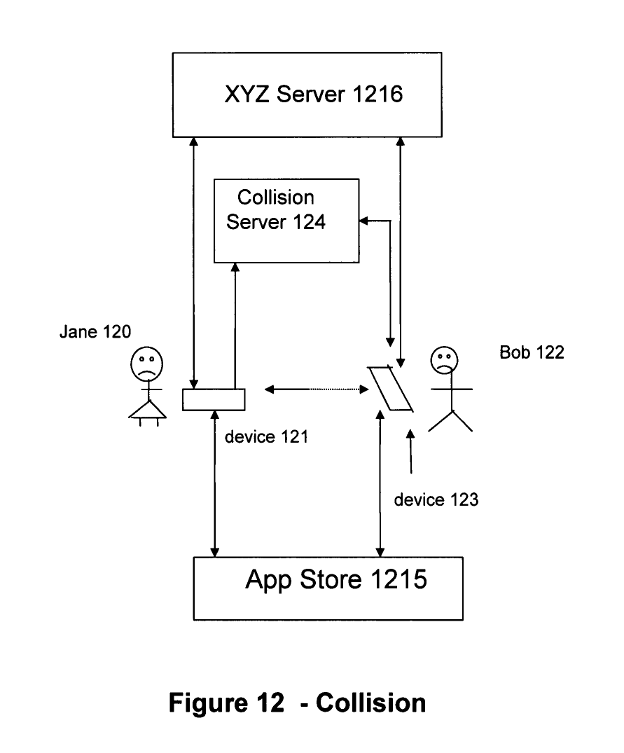

FIG. 11 is extended to FIG. 12. Jane 120 is running XYZ app on her device 121. Bob 122 is near her, with his device 123. He sees her use her app and wants a copy. She brings up the menu in FIG. 3 and picks Install 32.

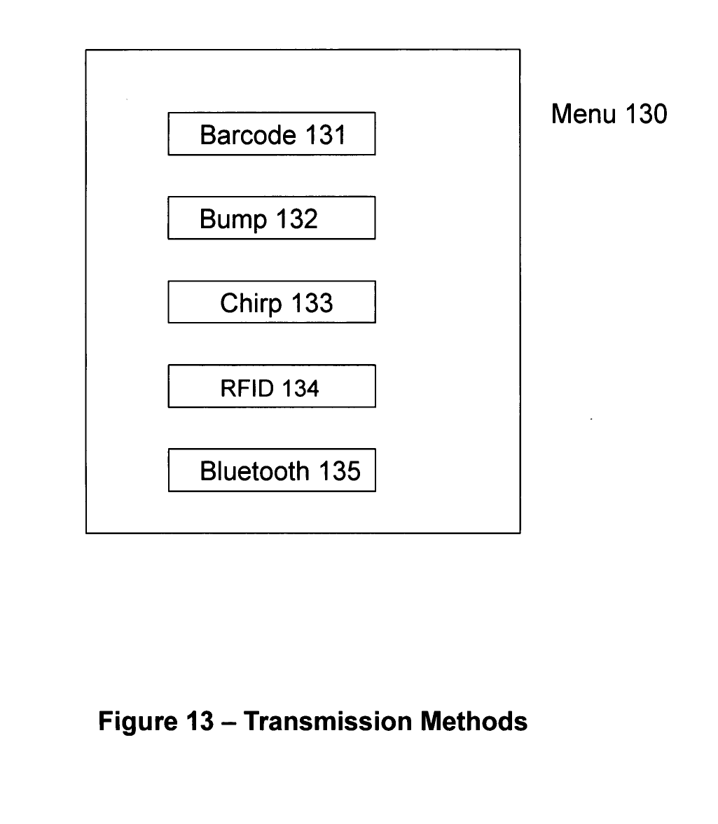

At this point, there might be another menu giving the transmission options. See FIG. 13. It shows Menu 130. There is the choice Barcode 131 which implicitly was picked in earlier sections, before we discussed these alternatives. There is the choice Bump 132, which is picked and explained in this section. There is the choice Chirp 133, which is picked in the next section. There is the choice RFID 134 and the choice Bluetooth 135. The latter 2 choices are not explicitly discussed further, but are obvious extensions of the other choices. There might be more choices on the menu, for other transmission means.

(If Barcode 131 is picked, there might be a submenu where the user can pick which barcode format to encode the DL.)

Return to FIG. 12. Jane's app gets a DL from App Store 1215 or from XYZ Server 1216. Or the app makes a DL, as discussed in earlier sections. This DL will be used by Bob's device to install an instance of XYZ from the server that made the DL. Jane's app uploads the DL to Collision Server 124. Jane 120 and Bob 122 bump their devices. The Collision Server downloads the DL to Bob device 123.

A DeepLinker is started on the latter device. It makes a query with the DL to the address in the DL. This causes the queried server to initiate an install of the app. Here, there might be other steps, if the server wants information from Bob, possibly including a payment.

The above discussion in this section is the use case of the Install, using collisions to transmit the DL between the users' devices.

The other use cases in earlier sections can be adapted to using collisions in a similar way. For brevity, we omit explicit discussion. The skilled reader should be able to infer the steps.

7: Chirp (Audio) Transmission of a Deep Link;

Another means of communicating between the devices in FIG. 1 is by sound, instead of using a barcode. This assumes that Jane's device can emit sound and Bob's device can record sound. One key case is when both devices are cellphones.

Recently, researchers Bergel and Steed at University College London released a product “Chirp” (cf. Chirp.io) that encodes data, like an URL, via what they term a shortcode as a short sound resembling birdsong in an audio range audible to humans. Cf. their US Patent Application 20120084131, “Data Communication System” [Bergel].

A device, like a cellphone or personal computer, encodes and emits this Chirp. Another device nearby might be able to detect this and, with the appropriate decoding or demodulating hardware and software, converts it to an URL, assuming that the decoded data is of this form to begin with. The detecting device would typically be a cellphone, inasmuch as it could intrinsically record audio. Then the software would launch a browser with that URL, if the device had Internet access, via either a phone carrier or a nearby WiFi or WiMax hot spot or some other wireless means.

The fundamental insight of Bergel used the longstanding idea of representing an arbitrary length bit sequence by a usually much shorter hash. Bergel also used the observation that the simplistic encoding of the former sequence as sound resulted in a lengthy sound, which was harder to transmit and receive. Instead, if the hash was encoded as sound, then the transmission of this was equivalent to transmitting the original signal, provided that the receiver could take the decoded hash and somehow map it back to the latter. The much shorter length of the hash resulted in a sound (aka. Chirp) that was in turn much shorter in temporal duration, and thus quicker to transmit and receive.

See also our submission “7”.

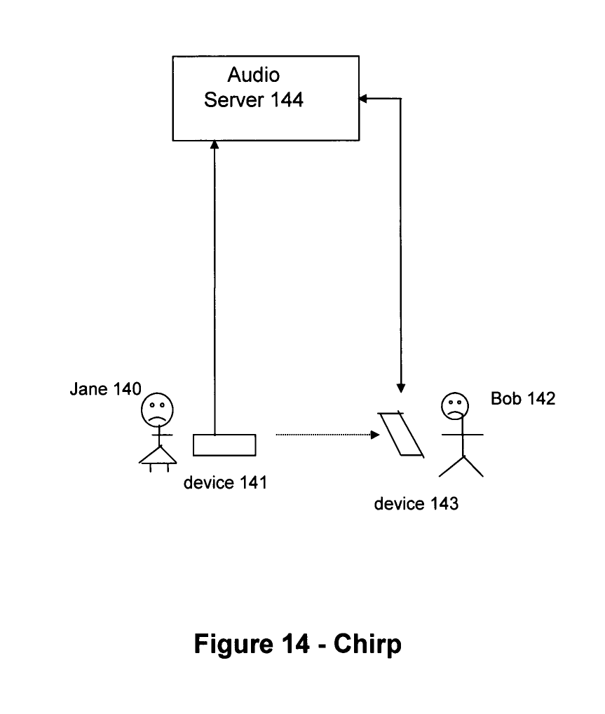

FIG. 14 shows Jane 140 with mobile device 141, and Bob 142 with mobile device 143. Jane starts app XYZ on device 141 that makes a DL. It uploads this to Audio Server 144 which is on an electronic network, assumed to be the Internet. Audio Server 144 stores that data and associates it with an id, which might be taken to be a hash of the data. The id is returned to Jane's device 141. The latter converts it to audio form. This is played.

Bob's device 143 records this and decodes to get the hash. Device 143 uploads the hash to Audio Server 144, which replies with the original DL. Once device 143 has that data, the current submission then proceeds as in the earlier sections, after the barcode was decoded by Bob's device.

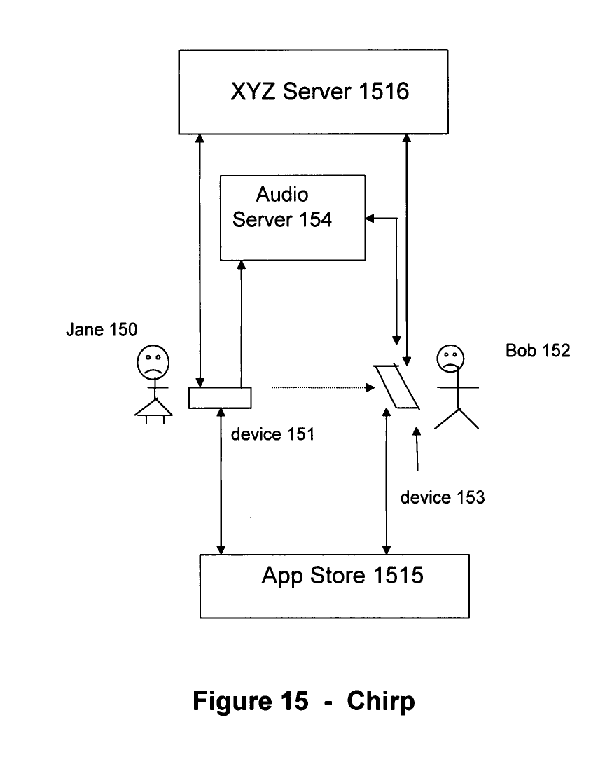

FIG. 15 shows to how incorporate FIG. 14 with the use case of Install. Jane 150 is using app XYZ on her device 151. Bob 152 is near her, with his device 153. She shows him the app. He does not have it and wants it on his device. She brings up the menu in FIG. 3 and picks Install 32.

At this point, there might be another menu giving the transmission options. See FIG. 13. It shows Menu 130. She picks the choice Chirp 133. Jane's app gets a DL from App Store 1515 or from XYZ Server 1516. This DL will be used by Bob's device to install an instance of XYZ from the server that made the DL. Jane's app uploads the DL to Audio Server 154. It sends a hash of the DL to her app.

Her app converts the hash to a “bird song” and plays it. Bob's device records it and gets the hash. It uploads the hash to the Audio Server 154 and gets back the original DL. The DeepLinker in Bob's device then submits the DL to the address in the DL. Which can be either the App Store 1515 or the XYZ Server 1516.

This causes the queried server to initiate an install of the app. Here, there might be other steps, if the server wants information from Bob, possibly including a payment.

The above discussion in this section is the use case of the Install, using audio to transmit the DL between the users' devices.

The other use cases in earlier sections can be adapted to using audio in a similar way. For brevity, we omit explicit discussion. The skilled reader should be able to infer the steps.

8: Other Transmission Methods;

Other wireless transmission methods are possible. For example, using NFC or RFID or Bluetooth. These require that both mobile devices have the appropriate transmitter and receiver for a given method.

The mechanisms of the earlier sections can be used with minor changes. If a method does not need an external server to hold the DL, then the method can be implemented in a similar way to using the barcode. Because the barcode could be made and decoded without using an external server. While if a method needs an external server, then the above sections for audio and bump should be consulted.

The details are left to the reader. In the interests of brevity, we do not rewrite the earlier sections for this.

9: Use Case=Other Apps;

All the prior use cases involved only one app. The Install use case was for two independent instances of the same app. While the other use cases were for essentially one instance of the same app being used. Where the second or subsequent users were able to watch or actively take part in the same instance as a first user.

This can be generalised. Imagine Jane running an app. Bob, who can be a stranger, comes along and she shows him the app. She might tell him that the company making that app has others, perhaps in the same “style”—like a genre of games. Bob wants to look at these apps, to perhaps install one.

Jane might pick a menu option in her app—item Other Apps 36 in FIG. 3. This causes her device to encode in a barcode a DL that points to the firm's app server. Bob decodes it. His DeepLinker gets the DL and goes to the app server. From the DL, the app server returns him a page where he can search the other apps. This search might not be across all the firm's apps, but perhaps those apps related to Jane's app. The page lets him install an app.

Above, when we said Jane's device makes a barcode that encodes a DL, of course following earlier sections, other methods can be used. Like making a chirp or bumping the devices. Or using other wireless methods.

10: Use Case=Trade;

Suppose Jane is playing an app that is a game XYZ. Bob is nearby and talks to her. Suppose, for example, that the game is a fantasy game, with items like gold coins and swords and armour. Jane has a certain number of each item. Bob is also playing XYZ. This can be the same instance as Jane, or an entirely different instance. He wants to swap or buy assets from her.

In the prior art, for them in the same game instance, they can do this inside the game by finding each other's character name.

See item Trade 37 in FIG. 3.

In this submission, for the above cases, Jane can make a DL that points to a page on the game server, listing her assets. These might just be those she wants to trade. She transmits this to Bob via the mechanisms described earlier. Bob's device DeepLinker gets the DL and goes to the server. His device gets the page. The page lets them trade.

One variant is where Bob can buy Jane's assets using real currency. Not using a fictitious currency that might be present in the game (e.g. “gold” coins). In the term “real currency”, we consider this to include “computational” currencies like Bitcoin.

11: Privacy;

In the above use cases, there was never a need for one user to tell the other her email address or any other electronic address of hers. There is a privacy advantage to this, separate from the usability issue of this submission's methods needing fewer manual steps.

Suppose Jane and Bob are strangers, in the use case of Install. If Bob sees Jane using her app and he wants to install it, then an alternative way of getting the app's name or DL by asking her to send him email entails him telling her his email address. Or equivalently, where he asks for her email address, so that he might query her later for details. Each person might be reluctant to divulge this to a stranger.

But in all our use cases, because there is no need for this, it encourages the greater uptake and spread of apps and the use of these apps.

12: Barcode to Control Screen;

Consider where a barcode encodes a DL. The DL points to an app server. The barcode might be printed as hardcopy on a poster or magazine page. Jane takes out her mobile device, which is assumed to have a camera, and scans the barcode. Her device decodes it, detects that it is a DL and starts a Deep Linker. Depending on various default policies of the Deep Linker and on whether Jane has altered these, the Deep Linker can load the DL and go to its address and download an app. And possibly install it.

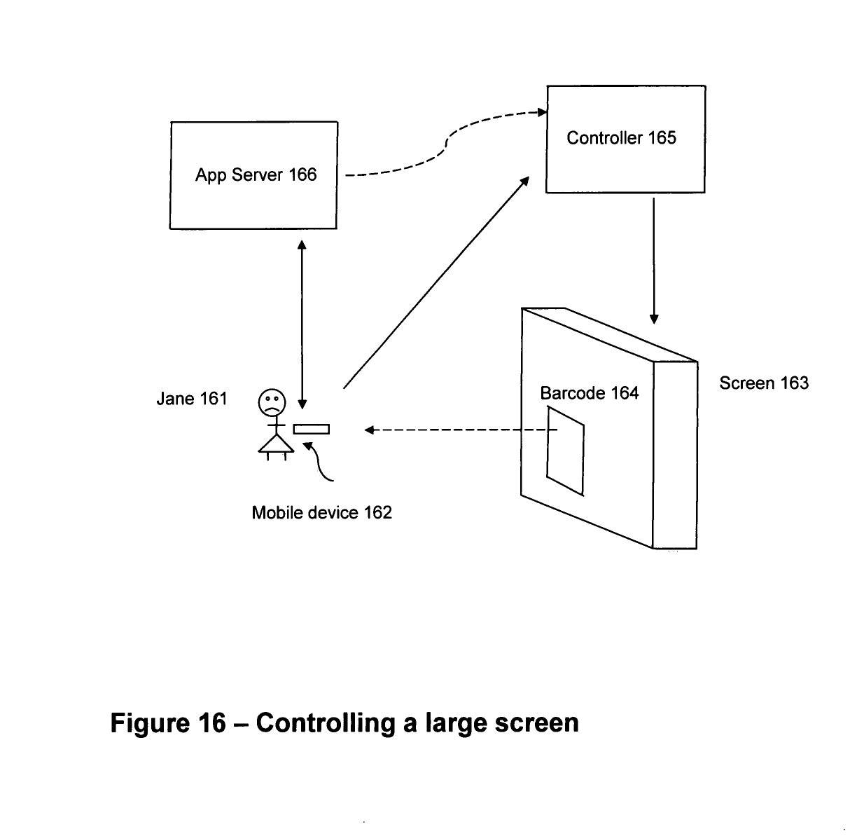

An elaboration of this is in FIG. 16. Jane 161 has mobile device 162 with a camera. She is near Screen 163 which is showing an image. The image includes Barcode 164. Screen 163 is controlled by Controller 165, which is on the same computer network as App Server 166.

Barcode 164 encodes a DL which points to App Server 166. When Jane scans Barcode 164, her device 162 installs and runs app XYZ, if XYZ is not already present on her device. Otherwise her device starts the app. In both cases, device 162 (via its Deep Linker) sends the DL to App Server 166. Though for the case where the app is already on the device, the DL might be altered in one of its parameters, to tell App Server 166 that an instance of XYZ is already on the device.

App Server 166 now begins an interaction with XYZ on device 162. But, crucially, App Server 166 also sends signals (controls and data) to Controller 165, telling it to alter Screen 163.

In other words, when Jane scanned the barcode on Screen 163, a feedback loop was implemented. She can now control Screen 163 through her app. In our first patent, “Cellphone changing an electronic display that contains a barcode”, U.S. Pat. No. 8,532,632, we described this for the case where the barcode encoded an URL. And where Jane's device started a web browser and loaded it with the decoded URL. The difference is that now a DL is encoded, and an app is run.

One consequence is that the graphical user interface that Jane encounters with app XYZ can be more flexible than via a web page. The latter is dominated by the HTML standard. While the GUI for an app allows for a greater, more general graphical experience.

Another difference is that if the app was installed from the App Server, then a payment might have been made by Jane. Whereas when a browser successfully downloads a web page, it is rare that payment is required simply to get that page.

Another difference is that the app might interact directly with Controller 165, if the latter has a Deep Link Server. This is indicated by the line between device 162 and Controller 165. In this case, the App Server might only be used to install the app to Jane's device, if needed.

This idea of using the barcode to transmit a DL to enable a feedback loop can be extended. An earlier section described encoding the DL via an audio emission. In the current section, the large screen might have a loudspeaker attached to it, that plays this audio. If Jane's device can hear this audio, it can decode it and call the audio server to get the DL. Then the resulting steps are as in this section, where Jane uses the device in a feedback loop to control the screen.

Likewise, other transmission means like using Bluetooth, infrared, NFC or RFID to encode the DL or an identifier of the DL can be used.

13: Adding identifiers to a DL;

Consider when Jane's device makes a DL without getting it from the App Server.

In general, this is better than asking the App Server for the DL since the wireless communication can be (much) slower than doing an internal computation on the device. Also, the energy cost is expected to be far less. A rough estimate is that the energy cost of wirelessly communicating a bit is 2 orders of magnitude more than doing a typical computation of a bit inside the mobile device.

This DL is transmitted by one of various means to Bob's device, where, say, his device uses the DL to contact the App Server. Either to install an app or to use it in some way with Jane's device. The firm running the App Server (which is assumed to be also the firm who wrote the app), would find it very useful to know an id of Jane's device or of Jane herself. Given the fundamental business value of the use cases discussed earlier. For example, Jane might be a big propagator of the app. It is vital for the firm to find and keep users like her. She might be given discounted prices on other apps that she uses.

An assumption is that earlier, before her interaction with Bob, Jane or her device has registered in some manner with the App Server. What is the distinction? If Jane uses several apps from the same firm on her device, the firm might find it more convenient to assign her or her device a single id. Or if Jane uses several electronic devices, and she uses items from the App Server on these devices, then the firm or her might find it more useful if she herself had an identifier (like a username). In earlier sections, we had spoken of the app putting an identifier of itself into the DL, so that the App Server knows which app is being invoked. The current section generalises that case.

Jane's device or app can insert in the DL an appropriate identifier. When Bob's device gets this and transmits the DL, or a modified form of it, to the App Server, the latter can extract the identifier and do analysis on it to find who or what was responsible for sending the DL to Bob.

Another identifier which can be added to the DL by Jane's device or app designates the means of transmission to be used to send the DL to Bob. FIG. 13 shows a menu of such transmission means.

In turn, the App Server can record this identifier when it gets the DL (or a modified DL) from Bob's device. Analysis can be done. For example, to see what is the most common form of transmission. Suppose this is using a QR barcode, while the second most common form is via a Data Matrix barcode.

The firm can consider whether to reinforce success by seeing if there are ways to faster encode or decode the QR code. Especially if data from other apps made by the firm also suggest the heavy use of QR. The firm could then release a faster encoder or decoder. If data about transmission could be shared between competing firms, then a collective decision could be made to do this (or not).

Or, suppose a rarely used transmission means is via chirp. The latter uses an audio server, or several servers distributed across the Internet. Is the audio server too slow? Can it be sped up.

The latter brings up another analysis possibility. The App Server can get some kind of geographic information about Jane and Bob. Perhaps as a condition of them using its app, one or both have to let their devices transmit some coordinate information to the App Server. The popularity of different transmission means can be studied to see if this correlates with location.

For example, suppose in Chicago the transmission by chirp is rarely done, while in Miami it is popular. Could this be because the audio server is too far from Chicago, leading to greater delays? One solution might be to emplace an audio server closer to Chicago. (The firm running the audio servers will in general be different from the firm running the App Server.)

Or is the audio method simply better known in Miami? This suggests that the audio server firm needs to publicise its method more in Chicago.

The app server firm might also use the data to guide the choices made by a user. For example, on the menu of transmission methods, it might indicate which is the most popular. This can be a function of location. This indication can be done when the app instance connects to the server. The server can download some small data, sufficient to indicate such collective choices.

This brings up the issue of search engines. There has been much speculation about how currently search engines (especially Google Corp.) have little insight into app usage, and how this might be improved upon with the introduction of DLs.

The data collected by the App Server using the methods of this submission might be spidered by a search engine. The suitably aggregated or otherwise anonymised data can then be used by the search engine, especially if it can get access to other App Servers run by other firms.

We claim:

1. A system of a first mobile device, Alpha, and a second mobile device, Beta; where Alpha runs an app; where the app makes a deep link; where the deep link has an address of an app server; where the deep link has an identifier of the app; where Alpha converts the deep link into a barcode; where Alpha displays the barcode; where Beta decodes the barcode; where Beta contacts the app server with a portion or entirety of the deep link; where Beta installs an instance of the app.

2. The system of claim 1, where the app server is an App Store run by a provider of a mobile device operating system.

3. The system of claim 1, where the deep link has an identifier of Alpha or of the user of Alpha; where the app server records this identifier.

4. The system of claim 1, where the deep link has an identifier of the transmission means; where the app server records this identifier.

5. The system of claim 1, where the barcode encodes two deep links; where a/the first deep link is for installing the app; where a/the second deep link is for running the app.

6. The system of claim 1, where the Alpha app writes an identifier of a/the Alpha operating system into the deep link.

7. The system of claim 6, where Beta extracts the identifier of the Alpha operating system from the deep link; where if the Alpha operating system and a/the Beta operating system differ, Beta does not contact the app server.

8. The system of claim 1, where Beta writes an identifier of a/the Beta operating system into the deep link; where the identifier is uploaded to the app server; where the app server downloads to Beta an instance of the app suitable for the Beta operating system.

9. The system of claim 1, where the app is a multiuser app; where the deep link has an identifier of a/the instance of the app on Alpha; where Beta runs an instance of the app; where the Beta instance is a second user of the instance of the app on Alpha.

10. The system of claim 1, where the deep link has an identifier of a/the instance of the app on Alpha; where the deep link has a parameter indicating observer status; where Beta runs the app; where the app server sends Beta data about the instance on Alpha; where Beta displays a read only instance of Alpha.

11. The system of claim 1, where the deep link has a parameter indicating that the instance on Alpha wants to terminate and transfer its data to another device; where Beta runs an instance of the app; where the instance on Beta is initialised with the data from the instance on Alpha; where the server terminates the instance on Alpha.

12. The system of claim 11, where the deep link has a parameter indicating that Alpha wants to resume at a future time; where the server retains a copy of the Alpha data, associated with Alpha; where Alpha at a future time runs the app; where the app connects to the server; where the server downloads a/the stored data.

13. The system of claim 1, where the deep link has an identifier of a group of apps on the app server; where the app server sends Beta information on the group; where Beta can search the group; where Beta can download an app from the group.

14. A system of a first mobile device, Alpha, running an app, and a second mobile device, Beta, running another instance of the app; where Alpha makes a deep link with an address of an app server; where the deep link has an identifier of assets in the app that Alpha wishes to trade; where Alpha encodes the deep link in a barcode; where Beta decodes the barcode; where Beta contacts the app server with a portion or entirety of the deep link; where the server sends Beta a description of the assets; where Alpha and Beta trade assets.

15. The system of claim 14, where Alpha lists the prices of the app assets; where the prices are in a real currency; where Beta buys one or more assets.

16. A system of a first mobile device, Alpha, and a second mobile device, Beta; where Alpha runs an app; where the app makes a deep link; where the deep link has an address of an app server; where the deep link has an identifier of the app; where Alpha uploads the deep link to an audio server; where the audio server returns an audio signal; where Alpha plays the audio signal; where Beta decodes the audio signal; where Beta contacts the audio server; where Beta gets the deep link; where Beta contacts the app server with a portion or entirety of the deep link; where Beta installs the app.

17. The system of claim 16, where the app is a multiuser app; where the deep link has an identifier of a/the instance of the app on Alpha; where Beta runs an instance of the app; where the Beta instance is a second user of the instance of the app on Alpha.

18. The system of claim 16, where the deep link has an identifier of a/the instance of the app on Alpha; where the deep link has a parameter indicating observer status; where Beta runs the app; where the app server sends Beta data about the instance on Alpha; where Beta displays a read only instance of Alpha.

19. A system of a mobile device near an electronic screen; where the screen is controlled by a controller on the Internet; where the screen shows a barcode encoding a deep link; where the deep link points to an app server on the Internet; where the mobile device scans and decodes the barcode; where the mobile device uses the deep link to query the app server; where the app server returns a first data to the mobile device; where the app server sends a second data to the controller; where the controller uses the second data to alter the screen.

20. The system of claim 19, where the mobile device uses the first data to make a query to the app server; where the app server sends a third data to the controller; where the controller uses the third data to alter the screen.
